(19) United States
(12) Patent Application Publication
(10) Pub. No.: US 2015/0327514 A1
(43) Pub. Date: Nov. 19, 2015

(54) SYSTEM AND DEVICE FOR DISPENSING PET REWARDS

(71) Applicants: David Clark, San Jose, CA (US); Simon Milner, San Jose, CA (US); Tom Daniel Lorey, Aptos, CA (US)

(72) Inventors: David Clark, San Jose, CA (US); Simon Milner, San Jose, CA (US); Tom Daniel Lorey, Aptos, CA (US)

(21) Appl. No.: 14/280,577

(22) Filed: May 17, 2014

(51) Int. Cl. A01K 15/02; H04N 7/18; G08C 17/02; A01K 5/02

(52) U.S. Cl. CPC A01K 15/021; A01K 5/02; A01K 15/025; H04N 7/183; G08C 17/02; G08C 2201/32

(57) ABSTRACT

A device for and method to provide pet rewards. The device includes a sound apparatus to alert a pet that a reward is about to be dispensed and a video camera wirelessly coupled to a remote user device to view the pet and the dispensing of a reward. Remote control of sounds, treat delivery, and pet viewing over a wireless connection can be provided with and through a user device. The method include connecting to a wireless network, a remote use device connection to the device, and the user device sending commands for sending video data, outputting sounds, and dispensing pet-rewards.

### CROSS REFERENCE TO OTHER APPLICATIONS

This application claims priority under 35 U.S.C. §119(e) of the co-pending U.S. provisional patent application Ser. No. 61/840,377 filed on Jun. 27, 2013, and titled “System and Device for Monitoring Pet Communication.” The provisional patent application Ser. No. 61/840,377 filed on Jun. 27, 2013, and titled “System and Device for Monitoring Pet Communication” is hereby incorporated by reference.

### FIELD OF THE INVENTION

The invention relates to pet-reward dispensing devices and systems wirelessly connected to a global network that can be remotely and automatically controlled.

### BACKGROUND OF THE INVENTION

There are limited device and methods to remotely dispense treats or other rewards to a pet. Devices wirelessly controllable over a global network are useful for checking on the welfare of a pet, dispensing of food, medicine at timed intervals, treats, and remotely dispensing other rewards. The ability for an owner to remotely see his pet and deliver a treat can give a pet owner the satisfaction of seeing their pet and monitoring their wellbeing. Further, the ability to administer medicines without being present and receiving a video clip that their pet has consumed the medicine is beneficial to the pet and comforting to the pet owner. What is needed is a system, methods and devices for dispensing rewards, dispensing medicine at timed intervals, and remotely checking on a pet. The present invention described below addresses these needs and provides a devices, methods, and systems satisfying the above mentioned needs.

### SUMMARY THE INVENTION

In one aspect of the invention a method for dispensing pet rewards is provided. The method includes providing a reward dispensing device that includes a housing. Within the housing is, a microcontroller, a sound generation apparatus, a video camera, wireless networking circuitry, and a reward dispenser. A power supply can be included within the housing or located external to the housing. The microcontroller is in communication with the power supply, the sound generation apparatus, the video camera, the wireless networking circuitry, and the reward dispense. The dispensing device makes a wireless connection that has network connectivity to a global network. A user device makes a network connection with the pet reward dispensing device through the global network and the wireless network. The user device can view the video data from the dispensing device and control the generation of sounds from the dispensing device, and the dispensing of rewards. Control of the dispensing devices is by one or more control messages from the user device sent through the global network.

In another aspect of the invention the dispensing device further includes a motion detector component. The reward dispenser automatically detects the presence of the pet, generates a sound to alert the pet that a reward is going to be dispensed, and a pet reward dispensed. In one embodiment, the video camera is enabled and a video clip of the dispensing of the pet reward and the consumption of an reward is made. The video clip can be either uploaded to a global network coupled server or stored internally to the pet dispensing device.

### BRIEF DESCRIPTION OF THE DRAWINGS

FIG. 1 is a block diagram illustrating an exemplary system in accordance with some embodiments of the present invention.

FIG. 2 is a block diagram of a network pet reward dispenser, training and pet communication device in accordance with one embodiment of the present invention.

FIG. 3 is a block diagram of an exemplary computing device suitable to implement the control and wireless-networking electronics for the pet reward dispenser.

FIG. 4 is a process diagram showing the steps for remote viewing of a pet, alerting a pet to the dispensing of a reward, and dispensing a reward.

FIG. 5 is a process diagram showing the steps for an automated means of viewing of a pet, alerting a pet to the dispensing of a reward, and dispensing a reward.

FIG. 6 is a figure of one embodiment of a sheet that can be used to enter network configuration parameters using a video camera.

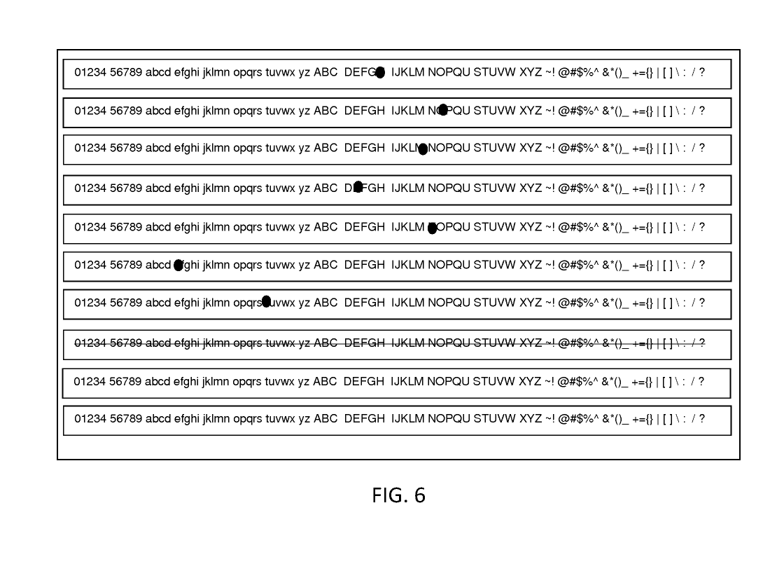

FIG. 7A is a cross-section view of the dispenser apparatus in the neutral position.

FIG. 7B is a cross-section view of the dispenser apparatus in the ejection position.

FIG. 7C is a front view of the dispenser apparatus.

FIG. 8 is a perspective view of an embodiment of the dispenser wheel.

### DETAILED DESCRIPTION OF THE INVENTION

The following descriptions are provided as an enabling teaching of several embodiments of the inventions disclosed. Those skilled in the relevant art will recognize that many changes can be made to the embodiments described, while still attaining the beneficial results of the present inventions. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

For the descriptions below, reference is made to storage and processing in the cloud. For the purpose of this invention, cloud computing, processing, and storage refers to distributed computing over a network with the ability to run a program over a network of many different connected computers at the same time. Cloud storage refers to the ability to store data on a remote non co-located network servers rather than a local server often managed by a different entity that the entity generating the data.

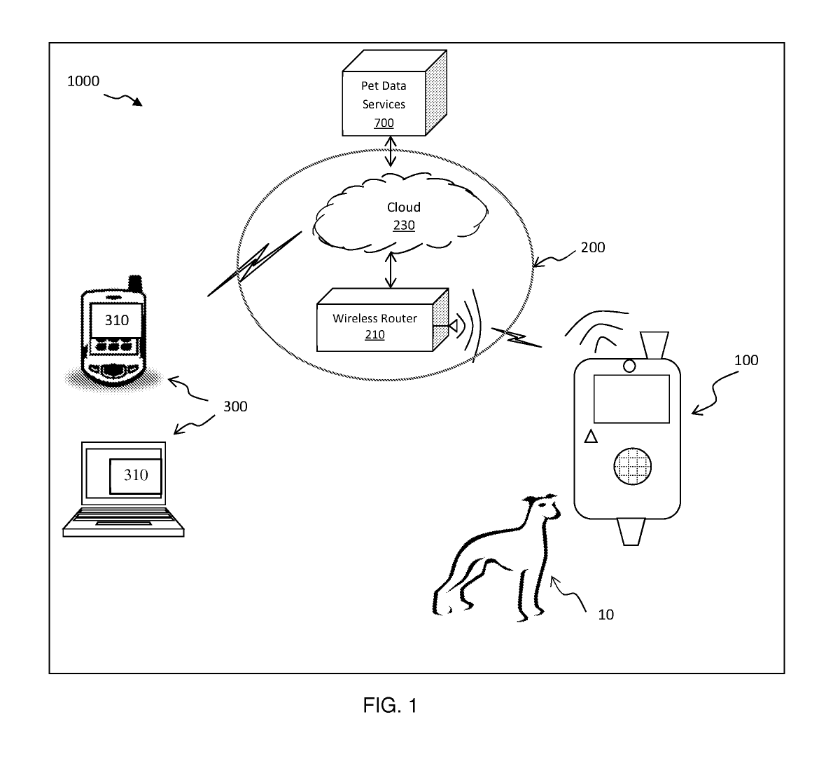

Referring to FIG. 1, a block diagram illustrates an exemplary embodiment of a system and devices in accordance with one embodiment of the invention. The diagram in FIG. 1 shows one embodiment of system and devices that provides for a pet owner to dispense a pet reward, train a pet to come to the device, and to view pet.

In the shown embodiment, the system 1000 comprises a device that interacts with the pet and a device that provide services for pets pet owners. The device that interacts and provides pet viewing data, the PRD (Pet Reward Device) 100, is wireless connected to a global network 200. A device that provide services for a pet include the PDS (pet data services) 700.

The PRD 100 provides for viewing of the pet 30 and control of the PRD 100 by the pet owner devices 300. The PRD 100 has control electronics configured to dispense a pet-reward including but not limited to a pet consumable treat under the control of a user device application 310, by an automated means through applications on the PDS 700, by a configurable application on the PRD 100, or a combination thereof. Interaction between the owner device 300 and the PRD 100 can be initiated by the owner or by the pet. The interaction can include but is not limited to audio clips, streaming video data, training tones, lights, dispensing pet-rewards, or combination thereof. Interaction with the pet 30 can be initiated by the user device 300 connecting to the PRD 100 and sending an electronic control message over the Internet 230 and through a wireless router 210 to the PRD 100. Alternatively, motion detector activation indicating pet 30 proximity to the PRD 100, can initiate recording a video clip, uploading the video clip to the PDS 700, dispensing a reward, and sending a notification message to the user device 300, or a combination thereof.

The PRD 100 is wirelessly connected with a global network 200 so that the pet viewing and control can be between the PRD 100 and any network 200 connected user device 300 or service PSD 700.

The PRD 100 can be configured with a compartment that contains one or more pet treats 175 or other rewards. Further, the PRD 100 can include electronic and software modules for generating sounds for alerting and training a pet 30 for receiving a reward from the PRD 100, or for use with the configuration of the PRD 100.

The network 200 is comprised of any global or private packet network or telecom network including but not limited to the Internet, private network, and cellular and telephone networks, and edge equipment access equipment including but not limited to wireless routers 210. Preferably the global network 230 is the Internet and cellular network running standard protocols including but not limited to TCP, UDP, and IP. The cellular network can include cellular 3G and 4G networks, satellite networks, cable networks, associated optical fiber networks and protocols, or any combination of these networks and protocols required to transport the pet information and control messages to and from the pet date services 700 and user devices 300. Preferably, the wireless connection between the PRD 100 and the wireless router 210 conforms to a Wi-Fi compliant standard including wireless Bluetooth 4.0 device to transmit the data to a network or the use of Wi-Fi 802.11x protocol and standards.

The PDS (Pet Data Services Device) 700 is a global network connected device that stores pet information including uploaded video clips and can provide services based on the stored pet data and user configured information. The services can include storing information associated with a pet and pet owner and generating HTML web pages based on the stored pet data, graphical history of information on a particular pet for a pet owner, warning messages for indications of problems with a pet, reminder messages for pet care, owner incentive message for good pet care, data mining of pet information for pet suppliers and pet providers, and using pet data and derived pet behavior for generating advertisements for user devices. Preferably, the PDS 700 is one or more computer servers coupled to the Internet.

The pet-owner user-devices 300 include any computer device that can connect to a global network 200 including but not limited to the Internet. This includes but is not limited to mobile phones, tablets, and notebook computers. Preferably the user devices 300 are configured with a hardware display and a microphone to support viewing video data or video clips from the pet devices 100 and associated display and hardware electronics and software capability to support the playback of a video stream or video clips, and the capability to connect to a global network.

### PRD (Pet Reward Device)

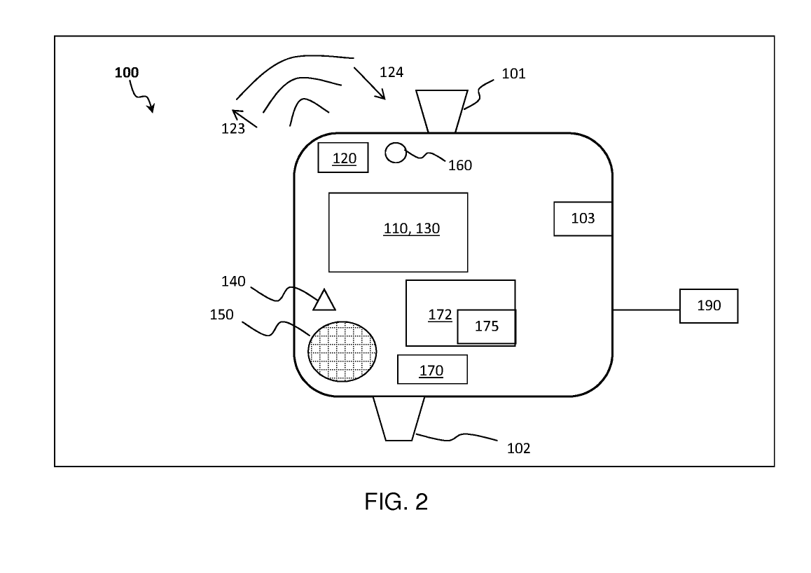

Referring to FIG. 2, a block diagram illustrates an exemplary embodiment of the PRD 100. The device is comprised of a wireless-networking component 120 that can include electronics and software required to implement the wireless networking communications with a global network. Further, electronics for generating audio output 150-FIG. 2, 151-FIG. 2, generating and transmitting video data 160, controlling the reward dispensing apparatus 170 processing a video input. Additionally, the PRD 100 includes a reward storage component 172, a means for loading rewards 101, an audio output device 150, a means for dispensing a treat 170, and a means for the pet to initiate treat delivery 140. Power for the PRD 100 can be from an internal power supply or an external power supply 190. The power supply is a commonly found supply that converts AC wall power to a DC voltage.

Preferably the wireless networking component 120 utilizes and is compatible with the WiFi 802.11x communication standards. However, other wireless transmission means are considered including but not limited to cellular 3G, 4G, Bluetooth and Zigbee. The wireless-networking component 120 and the device electronics 110-119, 130-136 includes all of the hardware and software to support the Internet protocols and protocol stacks for communications, including transport of video, and control data, between the PRD 100, the network 200, and to the PDS 700, the user devices 300, or combination thereof.

The pet reward storage component 172 can be internal to the PRD 100, can be a prepackage reward container that is attached or inserted into the PRD 100, or an external container that attaches to the PRD 100. Preferably the compartment or container is antimicrobial and is easily cleaned. Also, a removable reward storage component 172 that is dishwasher safe is contemplated.

The wireless electronic component 120 and electronics components 110-119, 130-136 provides the wireless networking functionality and control functions to deliver a reward 175 upon receiving a network control message. Further, the electronic components 110-119, 130-136 provides the functionality to interface with the video camera 160, optional video display 130, a means for detecting a pets presence, and to generate an audio signals for the speaker 150. The audio signals can be but are not limited to either a tone, used in training, a tone in the ultrasonic frequency range, or a music clip.

The video camera 160 can be any video camera electronics, preferably low cost. Exemplar of such video cameras electronics are the video camera electronics that are built into a personal computer and use for video conferencing. Preferably the display resolution and format that matches the display resolution of common mobile devices such as iPhones.

One means for the pet to initiate receiving a reward 175 can be from a motion detector 140. The motion detector can be a Doppler based ultrasonic, infrared, or radio frequency device or can use the images caught by the video camera 160 to either detect motion or use image recognition to recognize the pet. A motion detector is preferably set for short distance detection to prevent false reward releases. The detection of a continued pet 30 presence near the PRD 100 could be algorithmically processed as an indication that the pet wanted a reward 175.

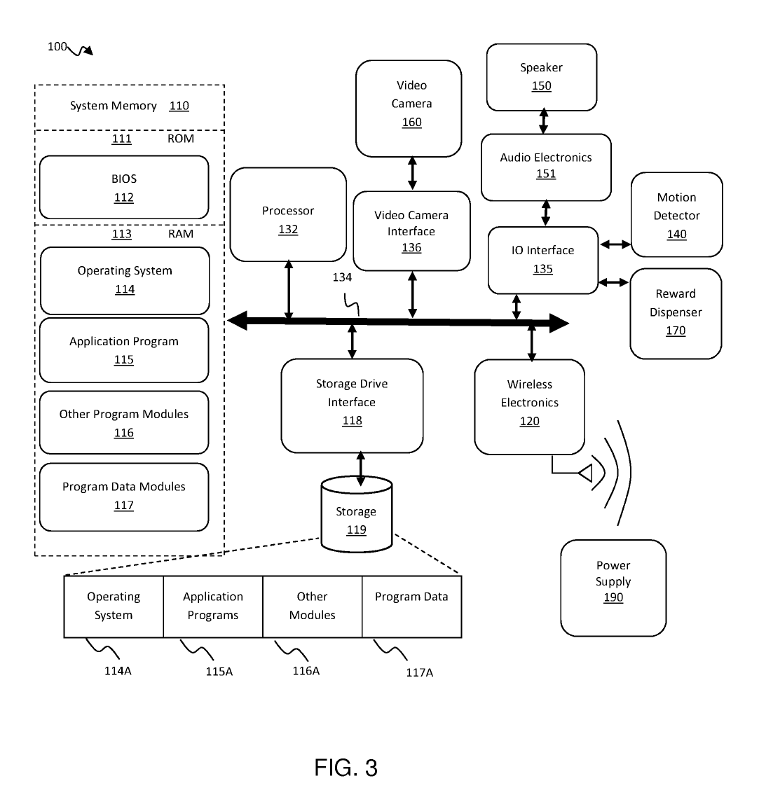

The reward distribution component 170 can include but is not limited to a solenoid operated door, a scoop, a receiving bay, a paddle for reward 175 ejection, or a combination thereof. The reward distribution component 170 is in communication with the reward storage component 172. The reward distribution component 170 can be invoked by a control message 124 received from the wireless network. The message 124 can originate from either the pet owner's user device 300, can be generated automatically by a pet data services device 700, can be generated by internal electronics FIG. 3-110-119, 130-136, or a combination thereof. The pet sound generator 150,151 can be any device that can output a recorded or generated sound. The sound generated can include a tone, a chime, a bell, or a combination thereof.

Referring to FIG. 3, a schematic depiction is shown of one embodiment of a PRD 100 that can be used in accordance with the invention. The PRD 100 is a self-contained processing system that includes a processor 122, system memory 110, storage 119 and storage interface electronics 118, a bus 134, wireless-communication electronics 120 for network communications, audio electronics 151, an audio output device 150, I/O Interface electronics 135, motion detector electronics 140, and a pet rewards dispenser 170. The PRD 100 contains machine executable instructions that when executing can received commands through the wireless electronics 120 from a global network coupled device, send video data from the video camera 160 to the wireless electronics 120, detect the presence of a pet with a motion detector 140, and automatically dispense a pet reward 175. A processor 132, for the purposes of this disclosure, includes a microprocessor or microcontroller.

The bus 134 represents one or more of any of several types of bus structures, including a memory bus or memory controller, a peripheral bus, and a processor or local bus using any of a variety of bus architectures. The system memory 110 includes ROM 111 (read only memory) and RAM 113 (random access memory). The ROM 111 comprises a BIOS 112 (basic input/output system) that contains basic routines for transferring data between elements within the PRD 100 such as during start-up. The PRD 100 further includes a storage drive interface 118 for reading from and writing to storage 119.

The storage device 119 provides nonvolatile storage of computer readable instructions, data structures, program modules, and other data for the PRD 100. Although the exemplary environment described herein employs solid state memory, it will be appreciated by those skilled in the art that other types of computer readable media which can store data that is accessible by a computer, such as hard disks, magnetic cassettes, flash memory cards, RAMs, ROM, and the like, can also be used in the exemplary operating environment. A number of program modules may be stored on the storage 119, including an operating system 114A, one or more application programs 115A including the pet reward and viewing application, other program modules 116A, and program data 118A.

The processor 132 can be any processor with sufficient processing power and sufficient memory address to support wireless connectivity space to support applications receiving video camera data from the video electronics 160, 161 and sending the data 123 out the wireless interface, receiving control messages 124, and controlling the reward dispensing apparatus 170. Preferably, the processor 132 requires minimal power and has a small foot print. A low power PRD 100 is a device powered by a power converter 103 that interfaces with the power grid. Preferably the processor 132 is part of an integrated device with system memory 110 and storage 119 and possibly other components such as a means for low power wireless transmissions.

The wireless electronics 120 can be for any type of wireless communication standard where the access point provides an identifier and the client device maintains a list of seen access points. Preferable, the wireless transmission supports wireless communication means commonly found on a mobile device such as mobile phone. The wireless standards IEEE 802.11 WiFi and IEEE 802.15 Bluetooth are two common communication standards that are commonly found on mobile devices.

The electronics is powered from either a housed or external power supply 190. The power supply 190 converts external AC power into DC power using standard transformer and electronics technology.

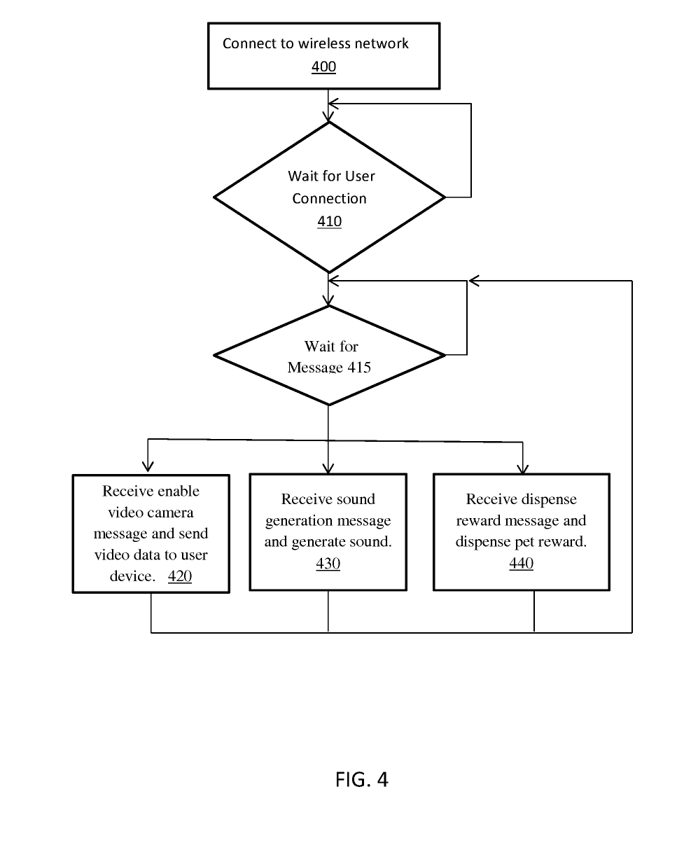

Referring to FIG. 4, a process diagram for user controlled dispensing of pet rewards is shown. The processing steps include various embodiments of the invention. Some steps can be excluded in different embodiments of the invention or can occur is different order.

In a step 400 the PRD 100 connects to the wireless network. The connection is made using standard protocols for wireless networks. For WiFi networks, a preconfigured network name and if required a password is utilized. Preferably the standards comply with the IEEE 802.11 Wi-Fi and IEEE 802.15 Bluetooth wireless standards.

In a step 410, the PRD 100 waits for a user device 300 to make a connection with the PRD 100 over the Internet.

In a step 415, the PRD 100 waits for a control message from the user device 300.

In a step 420, the PRD 100 receives a message from the user device 300. Within the message is an indicator to enable the video camera and send video data 122 to the user over the connection. Video data is sent over the wireless interface to the user device 300.

In a step 430, the PRD 100 receives a message from the user device 300. Within the message is an indicator to enable the sound generating electronics 151 is to output a sound that can include a tone, chime, a prerecorded music clip, or combination thereof. Preferable the sound is a sound that the pets were trained with to come to the PRD 100 and receive a reward 175. A sound is then output.

In a step 440, the PRD 100 receives a message from the user device 300. Within the message is an indicator to dispense a reward 175 from the reward dispenser 170. The reward dispenser 170 is controlled to release the reward.

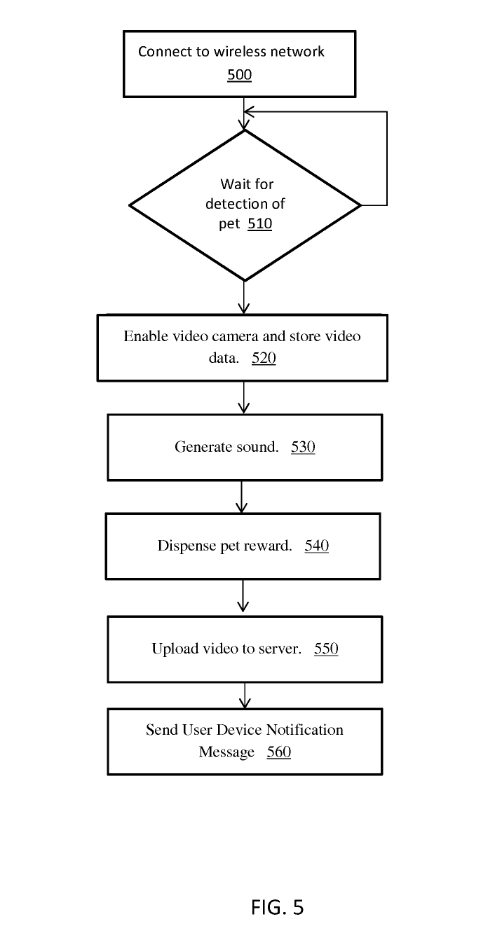

Referring to FIG. 5, a process diagram for an automated dispensing of pet rewards is shown. The processing steps include various embodiments of the invention. Some steps can be excluded in different embodiments of the invention or can occur is different order.

In a step 500 the PRD 100 connects to the wireless network. The connection is made using standard protocols for wireless networks. Preferably the standards comply with the IEEE 802.11 WiFi and IEEE 802.15 Bluetooth wireless standards.

In a step 510, the PRD 100 waits for an indication of the detection of the presence of a pet. Preferably the motion detector is set to only detect motions within three feet of the device. Upon the detection of a motion, the process proceeds to a step 520

In a step 520, the PRD 100 enables the video camera and stores the video data.

In a step 530, the PRD 100 generates a sound. Preferable the sound is a sound that the pets were trained with to come to the PRD 100 and receive a reward 175.

In a step 540, the PRD 100 dispenses a reward 175 from the reward dispenser 170. The dispensing a reward can include dropping a reward from the PRD or ejecting the reward from the PRD.

In a step 550, the PRD 100 uploads the video clip to a server connected to Internet. The video clip can be in standard formats including MPEG.

In a step 560, the PRD 100 sends a notification message to a user device. Notification messages can include but are not limited to email, texts, phone calls, posting to social network web sites, or a combination thereof.

### Operational Example

In operation the PRD 100 is used as follows. First a pet 10 is trained to receive a reward 175. A reward 175 can includes food, an edible treat, an edible treat that includes medicine, a play toy, or a combination thereof. The owner will connect, using an application 310 on his user device 300, to the PRD 100 through the Internet 230 and local wireless router 210. The pet owner will invoke through the owner's device 300 a message 124 to discharge pet reward 175 while the pet 30 is present. Either while the reward 175 is being released from the PRD 100 or within three seconds before the reward 175 release, a tone will be generated by the sound generator 150, 151. This process will be repeated until the pet 30 builds a mental association between hearing the tone and receiving a reward 175.

After the pet training is complete, the pet owner can remotely discharge pet rewards 175. The owner device 300 can connect to the PRD 100, through the network 200 to the PRD 100. The video camera 160 is enabled to stream a video data 123 to the user device 300. The owner can cause an message 124 to be sent to the PRD 100 to trigger the training tone generation from the sound generator 150 151. When the owner sees the pet 30 on his user device 300, the owner then causes a message 124 from the user device 300 to dispense a reward from the PRD 100. The owner can repeat the training tone until the pet comes to within viewing rage of the video camera 160.

In an automated mode, the pet 10 receives a reward 175 when the pet 10 is detected to be near the PRD 100. Detection is though the motion detector 140 or by movement detection by image processing of video camera data. When the pet 30 is detected close to the PRD 100, the training tone is generated and a reward 175 dispensed. This reward 175 delivery can be limited in a given time period to prevent the pet 30 from receiving too many rewards 175.

### Dispenser Components

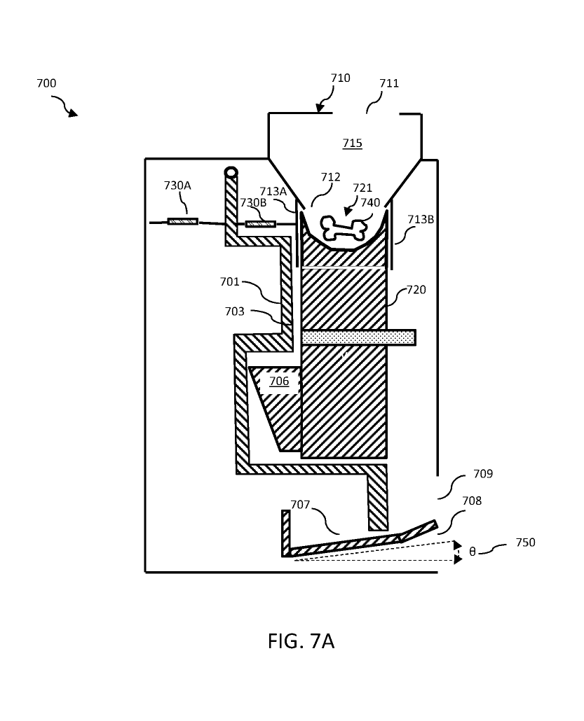

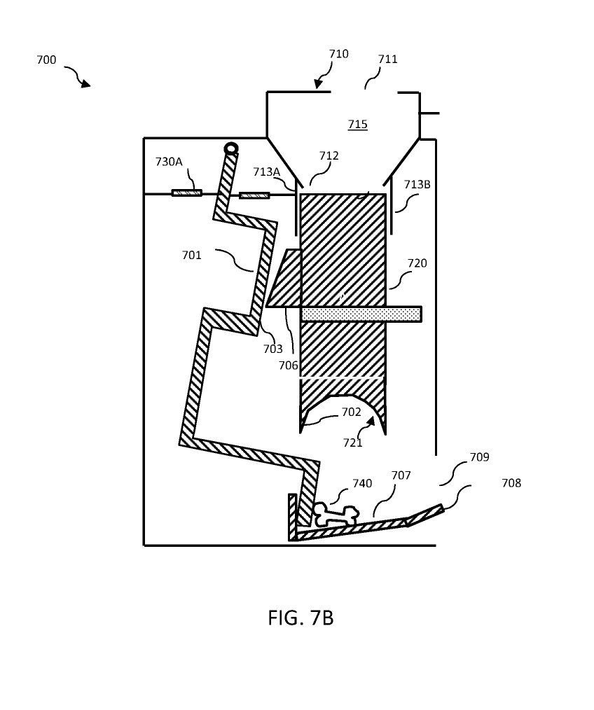

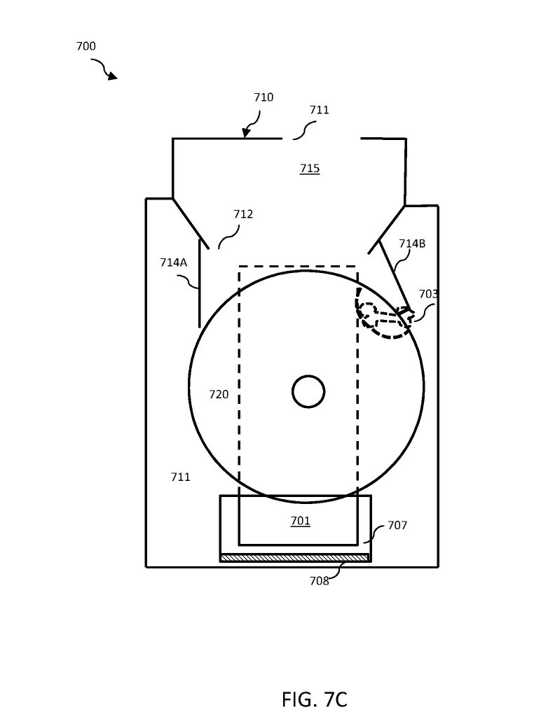

Referring to FIG. 7, one embodiment of a reward dispensing mechanism is shown and described. The dispensing components 700 consist of a reward repository and a reward dispensing mechanism.

### Reward Repository

The reward repository 710, in one embodiment, can be structured as a repository container 715 with round edges, corners and void of 90-degree angles and configured to hold a plurality of rewards 740. The rewards 740 include but are not limited to pet-edible treats, pet toys, or pet food. The reward storage cavity 715 is preferably configured with rounded edges. This structural configuration reduces the possibility of jams of rewards 740 and thereby enabling all pet rewards 740 to move to the bottom of the hopper effectively.

The repository 710 is positioned above a dispenser wheel 720 and is sized to hold a plurality of rewards 740. Preferably, the repository 710 has a top aperture 711 for loading rewards 740 and a lid covering the top aperture 711. The reward repository 710 delivers gravity fed rewards 740 through a bottom aperture 712 when and as the cavity 721 passes by the lower aperture 712 during wheel rotation 720.

Two of the reward repository's bottom-aperture sides 714A, 714B-FIG. 7C are adjacent and substantially parallel to the dispenser wheel surface 722-FIG. 7C containing a cavity 721 and substantially parallel with the dispenser wheel's rotation axis. One bottom-aperture wall 714A is located along the surface where the wheel 720 rotates into communication with the reward repository and the opposing bottom wall 714B is where the wheel 720 rotates out of communication with the repository 715. These two opposing sides 714A, 714B are spaced from each other to provide sufficient width for one or more rewards to be fall into the dispenser wheel cavity 721 as the wheel 720 rotates into communication with the repository storage 715 but not farther apart than the dispenser wheel diameter. Preferable these walls 714A, 714B are substantially adjacent to the dispenser wheel's cylinder's wall. Preferably the space between the wall and the wheel 720 is smaller the dimension of any reward 740. Preferable, the wall 714B where the wheel 720 rotates out of communication with the repository is flexible. The flexible wall 714B prevents a reward 740 that extends from the cavity 721 above the surface of the wheel side from jamming between the lower cavity wall 714b and the wheel 720 by flexing out of the way of the reward thus enabling the dispenser wheel 720 to continue to rotate. The two other lower dispenser walls 713a, 713B preferable conform to the cylindrical shape of the dispenser wheel 720 and are close enough to the dispenser wheel 720 to prevent rewards 740 from slipping between the wheel 720 and the walls 713A, 713B.

### Treat Dispense Mechanism

The dispenser wheel 720 is cylinder shaped having at least one cavity 721 in the cylinder walls. Preferably the cavity 721 is sized to hold at least one pet reward 740 substantially within the cavity 721. The wheel's axis of rotation is substantially horizontal and positioned so that the cavity 721 moves into communication with the reward repository storage 715 as the wheel 720 rotates. If the positions of the cavity 721 on the wheel cylinder is referred to in connection with a clock face, when the cavity 721 moves between the ten o'clock position to the two o'clock position, the cavity 721 is in communication with the treat storage repository 715. These positions can change but will not be less than 9 o'clock or greater than 3 o'clock.

As the dispenser wheel 720 rotates, one or more rewards 740 are gravity fed into the cavity 721. When the cavity 721 rotates past the bottom dispenser wall 714B, the reward 740 moves out of the reward storage 715 area and falls into a temporary collection area 707.

One embodiment of the dispensing wheel 720 is also configured with a spiral ramp 706 along one of the cylinder sides that engages with an ejector arm 701. The ejector arm 701 is configured with a tensioning 730A means, a pushing means 730B, or combination thereof that positions the arm 701 in a neutral position. The tensioning means 730B can comprise, but is not limited to a spring, an elastic material, a vacuum rod and piston, or a spring plate. The pushing means 730A can be a spring, a pressurized rod and piston, an electrical motor or combination thereof. The ejector arm 701 is also configured with a follower surface 703 configured to engage with the spiral ramp 706 as the wheel 720 turns.

As the wheel 720 turns, the ejector arm 701 is moved by the ramp 706 from a neutral position to an ejection position (see FIG. 7B). The wheel 720, ramp 706, and ejector arm 701 are configured for the ramp 706 to move along the follower surface 703 on the ejector arm 701 as the wheel 720 rotates. The ejector arm 701 is configured so that in the neutral position and that the arm's 701 equilibrium point is at the position closest to an ejection aperture 709. As the wheel 720 turns, spiral ramp 706 engages the ejector arm's follower surface 703 and extends the ejector arm's the tensioning means 730A, compression means 730B, or combination thereof in preparation for ejection of reward 740 dropped in the temporary collection area 707. The temporary collection area 707 is configured at an inclination 750 downward from the ejection aperture 709. The angle 750 is configured so that the reward 740 will slide to the back of the temporary collection area 707 and against the ejection arm 701. This configuration provides the benefit of giving a consistent kick by the ejection arm 701 to the reward 740. Thus the reward 740 will be ejected a substantially constant distance. The inclination angel is preferably between ten to forty degrees.

As the wheel 720 continues to turn, the spiral ramp 706 on the wheel 720 “falls off” of a shaped transition on the ejector follower surface 706 and thereby causing the ejector arm 701 to move in a swing motion towards the ejection aperture 709 of the dispenser 700 and back to the neutral position (see FIG. 7A). The position of the spiral ramp 706 and the cavity 721 is such that the reward 740 is dropped onto the temporary holding platform 707 after the ejector arm 701 transitions to the ejection position and thereby lobbing the pet reward 740 from the ejection aperture 709 as the arm 701 moves to the neutral position.

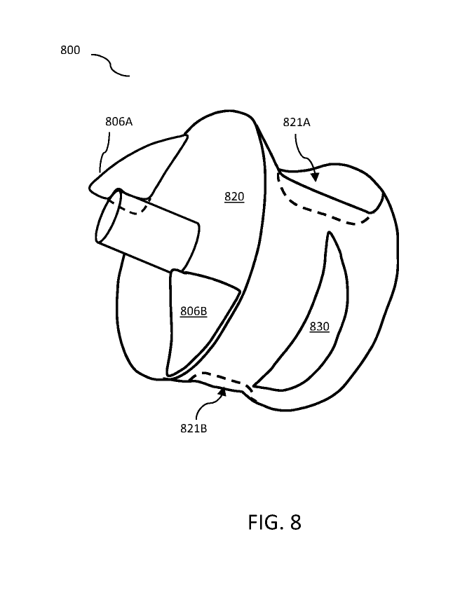

Referring to FIG. 8, an alternative embodiment of the dispenser wheel 800 is shown and described. The wheel 800 contains two cavities 821A, 821B within the cylinder 820 configured to receive a pet reward 740 as the wheel rotates into communication with the repository container 715. The wheel 800 contains two curved ramps 806A, 806B, that curve around the flat portions of the cylinder 820. Each ramp is positioned so that the treat 740 has been released before the ejector arm falls off the substantially vertical edge of the ramp 706A, 706B.

The distribution wheel 800 can include one or more agitator surfaces 830 located along the cylindrical cylinder walls of the wheel 820. As the agitator surface 830 rotates into communication with the reward storage component 172, it move the rewards 740 around with the beneficial effect of dislodging any rewards 740 that have become jammed together. The agitator 830 can be shaped as a fin, bumps, or an uneven surface. Preferable the agitator does not have any sharp angles in the direction of motion that could grab or catch a reward 740. The idea is to impart a displacement motion that can dislodge jammed rewards 740. Preferably the agitator extends at least the height of a reward 740 but not greater than three times the height of a reward.

### Streamed Pet Music

In one embodiment of a system, music is streamed and played from a network service coupled to a global network including but not limited to the Internet or cellular network through a wireless Wi-Fi router to a pet device. The pet device can include a music streaming module that is configured to receive digital pet music data, music, store the decode the pet music data, send the decoded pet music data to an analog output device, amplify the analog signal, and couple the amplified analog signal to a speaker enclosed in the pet housing.

The music module can be a software module within executable microprocessor code, a separate semiconductor device configured to decode and play the music, or a combination thereof. The music module can include electronics configured to decode or transcode the received data to be compatible with the electronic audio output device that is coupled to a speaker.

The music is preferable pet specific where it music is selected and modified to be more soothing to the pet. Exemplar of pet specific music includes removing gaps between songs.

### Training Tone

In another embodiment of the pet device, the pet device can output a training sound including but not limited to a tone, beep, jingle, a music tune when a pet reward is dispensed from the pet device Pet rewards can include but is not limited to a treat, food, medicine, or toy. The sound is used for training and generating an association by the pet between the sound and receiving a reward that has or is going to be dispensed from the pet device. After training, the sound can operate to alert the pet to come to the pet device and within viewing of the video camera.

In some embodiments, the sound generation is electronically coupled with a fixed or programmable delay between the sound and the reward delivery. In other embodiments, the sound is controlled by a user device including a mobile phone, personal computer, laptop, or tablet. For example, a user might connect wirelessly to the pet devices' video camera through the Internet. Next the user presses a button which sends a message to the pet device for the sound to be generated by the pet device. The user remotely watches a video stream from the pet device and waits for the pet to appear. Then the user causes a reward to be dispensed by a method including but not limited asserting a button or touching a virtual button on the mobile device screen.

In other embodiments, the sound can be programmed to go off automatically at a timed interval. For example, a dispensed treat can contain medicine for a pet that is best administered at timed interval. A pet owner may not be able to give the medicine at the required interval or be able to connect to the wirelessly connected camera to dispense the medicine containing treat. Thus, this automated system for dispensing a treat containing and medicine signaling the pet with a training sound is beneficial to the pet and owner. The signaling of for a reward can include other means for pets that have hearing problems. This can include a flashing light or a moving item including a spinning wheel or a display that has a patter which the pet was trained to associate with a reward.

In another embodiment, the pet device is configured with a motion detector. After the sound is triggered, either remotely through a user mobile device or by an electronic timer, the pet device can wait for an interval for an indication by the motion detector. Upon receiving the indication, the reward including but not limited to a treat, food, or medicine is dispensed. In one embodiment, if no motion indication is received by the pet device, the cycle will repeat and the tone will be output again.

In other embodiments, a video clip or digital picture can be taken either when the training sound is generated, when a motion indication is generated, when the reward is dispensed, or a combination thereof. The video clip is either uploaded wirelessly to a global network coupled server where a user can view the clip later on his mobile device or on another viewing device including but not limited to a personal computer, laptop, or tablet. Further, in some embodiments a push indication can be sent to a registered device, such as a mobile smart phone, to notify the pet owner that a treat of feeding has occurred. A push notification can include but is not limited to a text, email, phone call, fax, push notification, or combination thereof. The owner at that time can then attach to the network coupled server holding the video clip, either a server or the pet device, and view the pet's status.

### Temperature Measurement

In an embodiment of the pet device and system, the pet device can include a temperature sensor integrated into the pet device. The temperature sensor is coupled to a microprocessor/microcontroller in the enclosure of the pet device. The temperature sensor and can generate an electronically coded digital value that can be read by the microprocessor/microprocessor and sent from the pet device, through the wireless WiFi network and through a global network to a user device or to a server connected to a global network. The user device can be configured to connect though the Internet and a wireless connection to get the temperature data from the pet device or combination thereof. Alternatively the temperature data can be sent to a global network connected server, recorded, pushed to the user device, or a combination thereof.

### Network Setup Using Audio Tones

A challenge to setting up a WiFi enabled device is to enter the network configuration parameters including but not limited to network name and password without a keyboard or a wired connection to a laptop.

In one embodiment the pet device includes a microphone, coupled to audio electronics configured to convert audio sounds into digital values that are coupled to processing electronics that can include audio software. The audio electronics is configured with an anti-aliasing audio filter before the digital sampling circuitry. A typically sampling rate used in telecom communication is 8 k samples per second which allows for the use of commonly available electronic hardware. The processing electronics can be customized electronics or a microprocessor/microcontroller and a processing software module that processed the sampled audio data. In one embodiment, the process operates as follows.

In a first step, a device configured with a capability to connect to a wireless network checks to see if it has ever been configured with a specified network name and/or password. If not, then it goes to the configuration steps.

If the device is configured to connect to a specific network name, the device looks for the named wireless network named. If the device finds the named wireless network it tries to make a connection using a configured password if needed. If this fails or the network for which it has been configured is not found, then the device goes to a set of configuration steps.

In a first configuration step, the device processes sampled audio date. The purpose of the processing is to detect a series of audio sounds containing encoded information that are to be decoded into wireless configuration and other parameters for the device configuration. Since the expected amount of data for configuration is low, less than one hundred characters, the data rate can be low. Accordingly, the need for digital signal computational power is also be relatively low. Preferably, the processing of the digital audio data can be done by a microprocessor or microcontroller and without the need for a more costly digital signal processor.

In an optional step, a background noise level is determined. This can be determined by averaging the background noise power level for several seconds from the sampled digital data. The threshold level for determining the presence of a pulse, tone, or sound that represents a binary bit or symbol of transmitted data can be set to a power level 3 dB or greater above the background noise floor.

In a step, the digitalized sound data from the microphone is processed to look for a series of bit symbols representing a synchronization pattern. The pattern indicates the start of one or more configuration parameter bit sequences. In one embodiment, the symbols encoding data can be pulses of sound exceeding a threshold volume level. Either the relative pulse strength can indicate a “1” or a “0” or the absence of a pulse at a symbol interval will determine a symbol value. The timing for the symbols will need to be tracked. Ideally there are multiple digital audio samples between symbols. For example, at one symbol decision interval, a pulse indicates one binary level and the absences of a pulse can indicate a zero. In another embodiment, different frequency tones can be used to represent a one or a zero. The microprocessor can with low computational requirements count zero crossings of the digital data to determine which tone is being transmitted where each tone represents a binary level. One skilled in the art of digital data communication would be able to write demodulation software to extract the parameter data using commonly known techniques.

In a step, an application on the mobile device, including a mobile phone, a tablet, personal computer, is started and the configuration parameters are entered into the application a mobile device.

In a step, the mobile device is held in audio sound proximity to the device and uses its speakerphone capability or earpiece to output the sounds with encoded data. The sounds are generated by an application executing on a mobile device. The user asserts a button or other another indication to play the sounds and thus send the configuration parameters. In some embodiments the parameter information is enter into the mobile device and played to the device one field or one character at a time. After each character, field, or parameter entry, the pet device can flash a light, generate a sound, generated a spoken conformation indicating acceptance by the pet device. This configuration may require that a button be asserted on the pet device to begin the configuration process. These parameters are then configured into the pet device WiFi wireless electronics after which the pet device connects to the wireless network. In another embodiment, the pet device sends a

Push message to the user device as an indication of successful configuration of the pet device with the wireless network.

### Network Setup Using Video Camera

A challenge to setting up a wireless device including a WiFi connected device is to enter the network configuration parameters, including but not limited to network name and password, without a keyboard or a wired connection to a laptop.

In one embodiment, a video camera is used for entering configuration data into the device by holding a second device having a display in front of the video camera. The second device is preferably a smart phone with a application that changes the display between black and white or moves a pattern on the display. The timing of the changes is used to encode bit values, symbols, or indicated an encoding scheme. The video camera can include a video compression engine. Standard compression protocols provide frames of data that include motion estimation. The type of compression frame can indicate the change in the display pattern. Alternative, the compressed image data can be looked at to determine if there has been a change from white to black or black to white. This technique requires minimal processing power because it only requires the examination of parameters within a compression frame or looking at the frame parameter that indicates motion estimation.

In another embodiment the pet device includes a video camera which is configured to take a snapshot image of a piece of a paper held in front of the video camera. To configure the network parameters for the pet device, a user will make markings on a piece of paper with a known configuration. A user will mark out the characters corresponding to a configuration parameter. Each line will indicate a corresponding character. A space character can be indicated by a crossed out line.

As shown in FIG. 4, a user has marked out the characters for the network name HOMENet. The pet device will take a snapshot image of the marked up page and use image processing to determine what characters have been marked. One skilled in the art of image processing would know how to determine which characters have been marked.

Preferably the device will produce feedback when an image has been successfully processed. The feedback can be a tone, series of tones, jingles, LED that lights, or an LED that blinks. A specific tone can be used to indicate that there is an ambiguity in processing image. Different tones can be used to distinguish the difference between problems such as part of the image was cut off, or there was a problem determining which character was crossed out.

The next parameter, such as the password, can then be prompted to be input from a second marked up piece of paper. These parameters are then configured into the pet device Wi-Fi wireless electronics after which the pet device connects to the wireless network.

### Push to Message

In another embodiment of the system, a mobile user device can include a push to talk feature for sending audio data from the mobile device to be output the speaker on the pet device. When the pet owner desires to draw the pet to the pet device, the pet owner asserts a button on his mobile device or other device connected to the global network. When the button is release, audio transmission is terminated. The recording can be sent over the Internet and through the wireless network connected to the pet device. The recording can be stored on the user device, a networked coupled server, on memory in the pet device, or a combination thereof. The recording can then be output on the pet device speaker. The pet may respond to one person's voice better than another. A user may want to use one recording over another to entice the pet to come to the pet device.

What is claimed is:

1. A method for dispensing pet rewards comprising:
providing a dispensing device comprising a housing having therein:
a microcontroller,
a sound generation apparatus,
a video camera,
wireless networking circuitry, and
a reward dispenser;
the sound generation apparatus, the video camera, the wireless networking circuitry, and the reward dispenser being in communication with the microcontroller;
the dispensing device making a wireless connection with a wireless network that has network connectivity to a global network; and
a user device making a network connection with the dispensing device through the global network and wireless network.

2. The method of claim 1, further comprising the step of providing an external power supply wherein the power supply is in communications with the microcontroller, the sound generation apparatus, the video camera, and the wireless networking circuitry and reward dispenser.

3. The method of claim 2, further comprising the steps of receiving a control message from the network connection enabling the video camera transmission and sending video data to the wireless network.

4. The method of claim 3 wherein the video data is sent to the user device.

5. The method of claim 3, further comprising the steps of receiving a sound generation message from the network connection and the sound generating apparatus generating a sound.

6. The method of claim 5, further comprising the steps of receiving a reward dispensing message from the network connection and the reward dispenser dispenses a pet reward.

7. The method of claim 6, wherein the pet reward is a consumable reward and wherein the consumable reward includes a pet medicine.

8. The method of claim 1, further comprising the steps of providing a motion detector in communication with the microcontroller, detecting a motion within three feet of the pet device, enabling the video camera and storing the video data, generating a sound by the sound generations apparatus, waiting a configurable amount of time, dispensing a pet reward from the reward dispenser, stopping the recording of the video data, connecting to and sending the video data to a globally connected network service, and sending a notification to the user device of the recording.

9. A device for dispensing pet rewards comprising:
a housing having therein,
a microcontroller,
a sound generation apparatus,
a video camera,
wireless networking circuitry, and
a reward dispenser;
wherein, the sound generation apparatus, the video camera, the wireless networking circuitry, and the reward dispenser are in communication with the microcontroller;
wherein the wireless networking circuitry is configured to make a wireless connection with a wireless network having connectivity to a global network;
wherein the microcontroller is configured to receive a control messages from the wireless networking circuitry;
wherein the microcontroller is configured to enable the video camera and for video data transmission with to the wireless networking circuitry;
wherein the microcontroller is configured to enable and disable sounds with the sound generation apparatus; and
wherein the microcontroller is configured to control the dispensing of a pet reward with the reward dispenser.

9. The device of claim 8, wherein the microcontroller is configured to connect to and receive control messages from a user device.

10. The device of claim 9, wherein the control messages activates one or more of the video camera, the sound generation apparatus, or the pet dispenser.

11. The device of claim 8, further comprising the a motion detector in communication with the microcontroller, wherein the microcontroller and motion detector are configured to detecting a motion within three feet of the camera, enabling the video camera, storing the video data, generate a sound by the sound generations apparatus, waiting a configurable amount of time, dispense a pet reward from the reward dispenser, stopping the recording of the video data, and connect to and send to a globally connected network device the video data.

12. The device of claim 11 wherein the globally connected network device is a user mobile device.

13. The device of claim 12, further comprising power supply wherein the power supply is in communications with the microcontroller, the sound generation apparatus, the video camera, and the wireless networking circuitry and reward dispenser.
